(19) United States
(12) Patent Application Publication
(10) Pub. No.: US 2011/0234059 A1
(43) Pub. Date: Sep. 29, 2011

(54) System and method for toolbox

(76) Inventor: James L. Ellerbe, II, Shepherd, TX (US)

(21) Appl. No.: 13/065,465

(22) Filed: Mar. 22, 2011

Related U.S. Application Data
(60) Provisional application No. 61/316,256, filed on Mar. 22, 2010.

(51) Int. Cl. A47B 87/02; A47B 81/00; B23P 11/00

(52) U.S. Cl. 312/109; 312/249.8; 29/428

(57) ABSTRACT

A system and method for a toolbox that includes: a body configured to receive casters on a bottom portion of the body; a lid coupled to the body, the lid including a raised portion on a top exterior surface of the lid to facilitate stabilization of the toolbox in a stacked configuration with a second toolbox; a front door coupled to the body and substantially centered in a front side of the toolbox, wherein the front door is at least 2 feet by at least 2 feet in size; lifting elements coupled to an upper portion of the body on each side of the lid to facilitate lifting of the toolbox and also to facilitate stabilization of the toolbox in the stacked configuration; and skid components coupled to a lower portion of the body to facilitate lifting of the toolbox and also to facilitate stabilization of the toolbox in the stacked configuration.

### RELATED APPLICATIONS

This application claims the benefit of U.S. Provisional Application No. 61/316,256, filed Mar. 22, 2010.

### BACKGROUND

1. Field of the Invention

The present invention relates generally to a toolbox, and more specifically, to a toolbox having a substantially-centered front door and may include various types of toolbox, yard box, game box, work box, utility box, and so on. The toolbox is stackable and provides for increased access and organization inside the toolbox.

2. Description of the Related Art

This section is intended to introduce the reader to aspects of art that may be related to aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The use of tools, such as hand-held and larger tools, is omnipresent in society. Indeed, a multitude of craftspeople utilize tools in a vast variety of trades to operate, maintain, and repair machines, and to install, assemble, and disassemble various devices and systems, and the like. Further, hand-held tools are employed commonly for personal use at home or elsewhere for installations, assembly and disassembly of apparatuses, repair of systems and devices, and so forth. As is generally known, tools are typically kept in toolboxes, tool bags, drawers, and so on.

Toolboxes, such a general toolboxes, yard boxes, work boxes, utility boxes, game boxes, utility boxes, and the like, typically house tools and/or equipment. A toolbox, for example, may be compartmentalized, for carrying or storing tools or other items. Indeed, toolboxes may hold instruments, tools, equipment, and materials for work, for example. Toolboxes may be portable, positioned in a shop or work yard, for example, relatively small or large, etc. Moreover, such toolboxes may be a component or attached mechanism. In general, many types of toolboxes or yard boxes exist, and maybe constructed of various metals and plastics. These toolboxes may house a variety of tools, such as power tools, hand tools, air tools, mechanic tools, cutting tools, garden tools, machine tools, measuring and alignment tools, other tools, tool supplies and accessories, and so on.

### SUMMARY OF THE INVENTION

In an aspect of the invention, provided is a toolbox including: a body configured to receive casters on a bottom portion of the body, wherein the casters comprise wheels that facilitate movement or relocation of the toolbox; a lid coupled to the body, the lid comprising a raised portion on a top exterior surface of the lid to facilitate stabilization of the toolbox in a stacked configuration with a second toolbox; a front door coupled to the body and substantially centered in a front side of the toolbox, wherein the front door is at least 2 feet by at least 2 feet in size, and wherein the front door and the lid provide for multi-access to an interior of the toolbox, and wherein an enclosure of the toolbox is formed by a combination of the body, the lid in a closed position, and the front door in a closed position; lifting elements coupled to an upper portion of the body on each side of the lid to facilitate lifting of the toolbox and also to facilitate stabilization of the toolbox in the stacked configuration; and skid components coupled to a lower portion of the body to facilitate lifting of the toolbox and also to facilitate stabilization of the toolbox in the stacked configuration.

Another aspect of the invention provides for a method of manufacturing a toolbox, the method including: constructing a body frame, a door frame, and a lid frame; installing panels on the body frame, the door frame, and the lid frame to form a body, a door, and a lid, respectively, wherein the lid comprises a gable configured to facilitate stability of the toolbox in a stacked configuration with another toolbox; installing a lid handle on the lid and a door handle on the door; coupling the door substantially centered to a front of the body; coupling the lid to an upper portion of the body; coupling lifting elements on an upper portion of the body, wherein the lifting elements facilitate lifting of the toolbox, and also facilitate stability of the toolbox in the stacked configuration; and coupling skid components on a lower portion of the body, wherein the skid components facilitate lifting of the toolbox, and also facilitate stability of the toolbox in the stacked configuration.

In yet another aspect, the invention provides a stacked configuration including a first toolbox and a second toolbox stacked on top of the first toolbox, wherein the first toolbox and the second toolbox each comprise: a body; a lid coupled to the body, the lid comprising a raised portion on a top exterior surface of the lid; a front door coupled to the body and substantially centered in a front side the body, wherein the front door is at least 2 feet by at least 2 feet in size, and wherein the front door and the lid provide for multi-access to an interior of the body, and wherein an enclosure is formed by a combination of the body, the lid in a closed position, and the front door in a closed position; lifting elements coupled to an upper portion of the body on each side of the lid to facilitate lifting; and skid components coupled to a lower portion of the body to facilitate lifting. Further, the lifting elements of the second toolbox engage the skid components of the first toolbox to reduce front-to-back motion and back-to front motion of the first toolbox with respect to the second toolbox and of the second toolbox with respect to the first toolbox. In addition, the raised portion of the lid of the second toolbox engages the skid components of the first toolbox to reduce side-to-side motion of the first toolbox with respect to the second toolbox and of the second toolbox with respect to the first toolbox.

### BRIEF DESCRIPTION OF THE DRAWINGS

Advantages of the invention may become apparent upon reading the following detailed description and upon reference to the drawings in which:

FIG. 1 is a perspective view of an exemplary toolbox for housing tools, equipment, and/or materials in accordance with embodiments of the present techniques;

FIG. 2 is a perspective view of the exemplary toolbox of FIG. 1, with the front door open in accordance with embodiments of the present techniques;

FIG. 3 is a perspective view of an another exemplary toolbox similar to the toolbox of FIG. 1, and showing internals of the toolbox in accordance with embodiments of the present techniques;

FIG. 4 is a perspective view of an exemplary interior toolbox inside the toolbox of FIG. 3 in accordance with embodiments of the present techniques;

FIG. 5 is a perspective view of a shelf and bins inside the toolbox of FIG. 3 in accordance with embodiments of the present techniques;

FIG. 6 is a perspective view of toolbox frames of yet another exemplary toolbox in accordance with embodiments of the present techniques;

FIG. 7 is a perspective view of the toolbox frames of FIG. 6 with the door frame closed in accordance with embodiments of the present techniques;

FIG. 8 is a front view of a completed toolbox based at least in part on the toolbox frames of FIG. 6 in accordance with embodiments of the present techniques;

FIG. 9 is a top view of the toolbox of FIG. 8 in accordance with embodiments of the present techniques;

FIG. 10 is a side view of the toolbox of FIG. 8 in accordance with embodiments of the present techniques;

FIG. 11 is a front view of toolbox frames generally in accordance with embodiments of the present techniques;

FIG. 12 is a perspective view of yet another embodiment of an exemplary toolbox in accordance with embodiments of the present techniques;

FIG. 13 is a perspective view of two of the toolboxes of FIG. 12, one stacked on the other, in accordance with embodiments of the present techniques;

FIG. 14 is a perspective view of two of the toolboxes of FIG. 12, one stacked on the other, bottom toolbox having an opened door, in accordance with embodiments of the present techniques;

FIG. 15 is a block flow diagram of manufacturing a toolbox in accordance with embodiments of the present techniques; and

FIG. 16 is a block flow diagram of a method of customizing a toolbox in accordance with embodiments of the present techniques;

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill in the art and having the benefit of this disclosure.

The present techniques generally provide for utility and toolboxes, and the like (e.g. yard boxes, game boxes, heavy-duty boxes, mechanic boxes, etc.). The boxes may be employed for work and/or for personal use. In certain examples, the boxes may be categorized as: (1) standard boxes; or (2) heavy-duty boxes. Of course, boxes of the present techniques may overlap in these two categories or be of other types. Moreover, these two categories may be further distinguished by features and other nuances. Product options and features may include a front door, lid, legs, casters (e.g., 2″, 3″, 4″, 6″, 8″, etc.), security features such as security tie down security door catch and so on, electrical components such as lid light and exterior outlets and the like, moisture protector liners, and so forth. In all, differing models with various features and options may be implemented, depending on the application, for example. Indeed, there may be multiple versions having differing features. However, in certain example, a standard (off-the-shelf) basic design may be implemented but at differing sizes and/or accessories:

As indicated, the toolbox may employ a door. The door may be substantially centered in the front, back, left side, or right side. In certain embodiments, the door is a front door which may be substantially centered in the front of the box. In some examples, the door may be about 2 feet or greater (e.g., about 2.5 feet. 3 feet, 3.5 feet, etc.) in size, i.e., in width and/or height. This unique substantial centering of the door may provide for improved access inside the toolbox, convenient storage space on either side of the door, increased structural strength of the toolbox, and so on. Indeed, the uniquely centered front door provides for improved access in the toolbox and also facilitates installation of binds or shelves on each side of the toolbox. Moreover, as confirmed per empirical testing, centering the front door (as opposed to a non-centered door) provides for increased structural integrity and increased weight capacity of the toolbox.

In certain examples, the toolboxes of the present techniques can be specialized or customized for a particular job (in many cases without significant reconstruction). Further, again, electrical lighting, caster mobility, security features, and so on, may be incorporated. Moreover, in certain embodiments, the boxes can be picked up or lifted from the bottom, such as with a lifting device (e.g. a fork lift). Depending on the embodiment, the bottom lifting weight capacity may range from about 1000 lbs. to 2000 lbs. or more. Of course, certain embodiments of the box itself may weigh less than 700 lbs. (e.g., 150 lbs., 200 lbs., 250 lbs., 300 lbs., 350 lbs., 400 lbs., 450 lbs., 500 lbs., 550 lbs., 600 lbs., 650 bs., and weight values therein). Moreover, as appreciated by the skilled artisan, the weight capacity may be a function of the disposition of the box, such as if it is static, mobile, and so on,

The boxes may incorporate two or more legs or casters/wheels. It should be noted that the type of casters employed may affect the weight of the box. Moreover, differing legs or casters or wheels may be employed, depending on the intended surface of use. For example, certain wheels may be avoided, for example, if they would sink into the intended soft ground of use. In another example, rocky terrain may benefit from a certain types of wheels. Consequently, caster plates may be incorporated to facilitate the use of different types of casters.

Further, the boxes of the present techniques may be multi-accessible. For example, the boxes may be a dual access box. In certain embodiments, the dual access may be provided by: (1) the top lid may be opened (e.g., locked or fixed open); and (2) the front door opened facilitating walk-in, for example. Again, the dual or multi-accessible function may provide convenience as the lid can be raised to a lock position and the door can be opened for walk-in accessibility in certain embodiments. Moreover, in operation of some embodiments, the door (e.g., hinged) may be shut and latched, then the lid is closed by pulling down the handle of the lid (e.g., substantially at the center of the lid), and the lid then closed, thus interlocking both the lid and door to provide security and to facilitate usability. Moreover, it should be noted that the toolboxes may be large enough for a person to walk into the toolbox through an opened door.

Furthermore, as indicated, the boxes may be customizable and utilized for many applications, and therefore, size, material and design for each individual function may vary and accommodate accordingly. Various bulk materials and sizes of those materials may be employed. In some examples, bulk material includes 2½″ (or less) metal track for the metal frame of the floor and the walls, which may differ in thickness and type of material. In certain embodiments, 24 gauge or greater galvanized sheet metal may be used for the exterior sides and floor covering. In examples, ⅛″ and ½″ rivets or other fasteners may be used for attaching and securing the toolbox assemblies. Material and size selection may be based, at least in part, to reduce the gross weight and cost. At relatively less weight, the box is easier to move or carry without significantly sacrificing the integrity and weight capacity. Further, certain polymers or steels or other materials may be incorporated to improve certain features for particular applications. Also, as discussed below, features provide for stacking of the toolboxes.

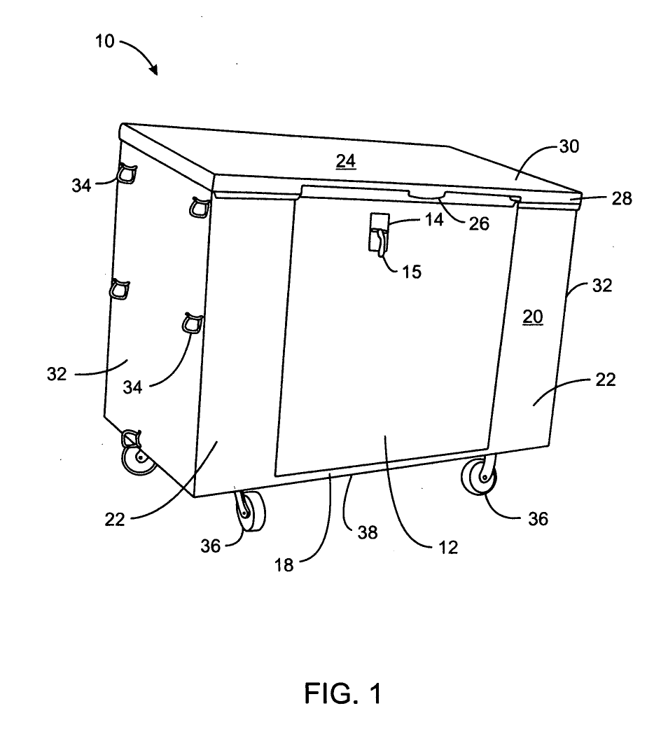

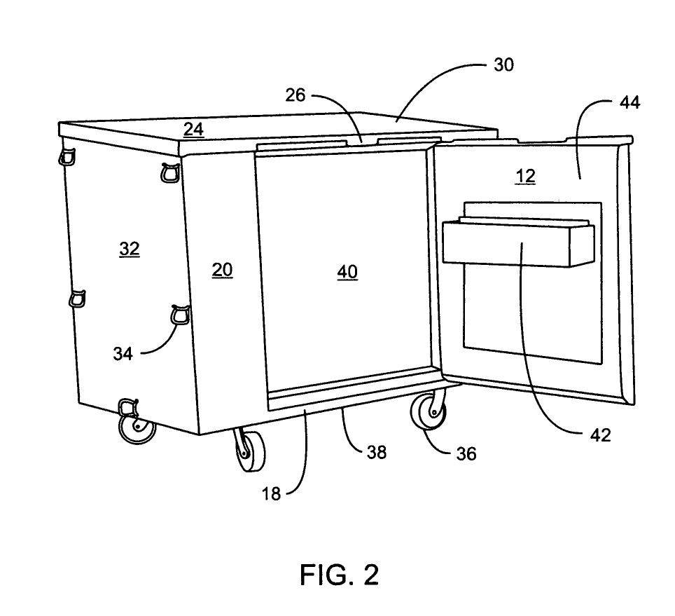

Turning now to the drawings, FIGS. 1 and 2 are perspective views of an exemplary toolbox 10. Tools and equipment may be housed in the toolbox 10 in such a way to provide ready access to those items. The exemplary centered front door 12 is closed in FIG. 1 and opened in FIG. 2. The front door 12 in this example is about three feet in height and three feet in width. Of course, the height and width could have different lengths. Further, it should be emphasized that the toolbox 10 and also its door 12 may be smaller or larger than depicted.

Moreover, the door 12 may have a handle 14 to open the door 12. The handle 14 may be situated on different locations of the door, and may incorporate various coupling or latching elements. In the illustrated embodiment, the handle 14 has a lever 16 that is pulled upward to release the door 12 from a closed position (FIG. 1) to an opened position (FIG. 2). A threshold 18 (to receive the door 12) is situated on the front 20 of the toolbox 10 below the door 12. Also, it should be noted that the front sides 22 on each side of the centered door 12 may provide surfaces on the interior of the toolbox 10 to mount certain accessories, such as shelves, bins, etc. Moreover, the interior of the door 12 may also provide a surface to mount such accessories.

The toolbox 10 has a lid 24 having a handle 26 for lifting the lid 24. In certain embodiments, the lid 24 may need to be in a raised or open position for the door 12 to be opened. However, as depicted in FIG. 2, the door 12 may be opened without opening or raising the lid 24. Further, the lid 24 may have a lip 28 that engages the upper portion of the toolbox 10. In the illustrated embodiment, the lid 24 extends to the outer edges of the toolbox 10. In addition, the lid 24 may have security or locking features that engage the other parts of the toolbox 10 to secure or lock the lid 12. Moreover, the top exterior surface 30 of the lid 24 may be flat and aligned with the horizontal. On the other hand, the lid may be slanted to facilitate water (rain) runoff, for example. In other cases, as discussed below, the surface 30 of the lid 22 may incorporate a gable or other projected surface to facilitate stabilizing stacking of the toolboxes 10.

On the sides 32 of the toolbox 10, coupling elements 22, such as rings, d-rings, clamps, etc. may be positioned to provide for lifting of the toolbox 10. Further, the toolbox 10 may have permanent or detachable wheels or casters 36 on the bottom 38 of the toolbox 10 to facilitate movement or rolling of the toolbox 10. Lastly, as shown in FIG. 2 (with the door 12 revealing the interior 40 of the toolbox 10), a shelf or bin 42 may be disposed on the inside surface 44 of the door 12.

Furthermore, as indicated, the toolboxes 10 may be standardized (or customizable) and utilized for many applications, and therefore, size, material and design for each individual function may vary and accommodate accordingly. Various bulk materials and sizes of those materials may be employed. In some examples, bulk material includes 2½″ (or less) metal track for the metal frame of the floor and the walls, which may differ in thickness and type of material. In certain embodiments, 24 gage or greater galvanized sheet metal may be used for the exterior sides and floor covering. In examples, ⅛″ and ½″ rivets or other fasteners may be used for attaching and securing the box assemblies. Material and size selection may be based, at least in part, to reduce the gross weight and cost. At relatively less weight, the box is easier to move or carry without significantly sacrificing the integrity and weight capacity. Further, certain polymers or steels or other materials may be incorporated to improve certain features for particular applications.

Discussed briefly are three examples with regard to toolboxes 10 of FIGS. 1 and 2 (and other embodiments). These three examples are meant to illustrate (not limit) the present techniques. In the first example, a yard box has adjustable bins on both sides and about a five foot adjustable shelf in the back. The yard box weighs approximately 200 lbs., depending on the caster wheels installed and other possible adjustments. The weight capacity may be up to 1000 lbs. or less. In this example, the bins and shelving are adjustable and removable. The lid overlaps the door, securing the door via a pad lock for security. Of course, the lid overlapping may change other desired ways or means of locking the box.

In the second example, a large toolbox has a heavy duty adjustable back wall shelf for about a three foot wide smaller toolbox (or smaller) inside the overall larger toolbox with bracing configured to give more space on the sides inside the overall larger toolbox for various tools (e.g., for compressors, retractable chords/hoses, etc.). There are also two adjustable bins on each side of the interior 3′ toolbox and still have the two bins on each side of the door on the front wall. The bins and shelving are adjustable and removable, as well as the interior 3′ toolbox. The lid overlapping the door is employed, but may be modified or replaced to other ways of locking the box.

In the third example, a heavy duty box is a commercial game brand (e.g., weighing 450 lbs., 500 lbs., 550 lbs., etc.) capable of about a 2000 lbs. capacity and can be lifted by the top side with a crane using four exemplary d-rings at each corner. The frame is built heavy duty and has double panels giving increased security and ruggedness. The lid and locking design facilitates front door entry without lifting the lid and still giving security utilizing a dead bolt effect. In this example, a 5′ fixed ¼″ angle iron rack/shelf that is incorporated that can hold come longs, etc., for example, and is removable if needed. The bins, one on each side of the front wall in this example, are also fixed and relatively sturdy and not as easily removable. Lockable compartments in the front walls for personal items and so forth, may also be employed. Different types of bins and shelving can be placed in various locations if desired.

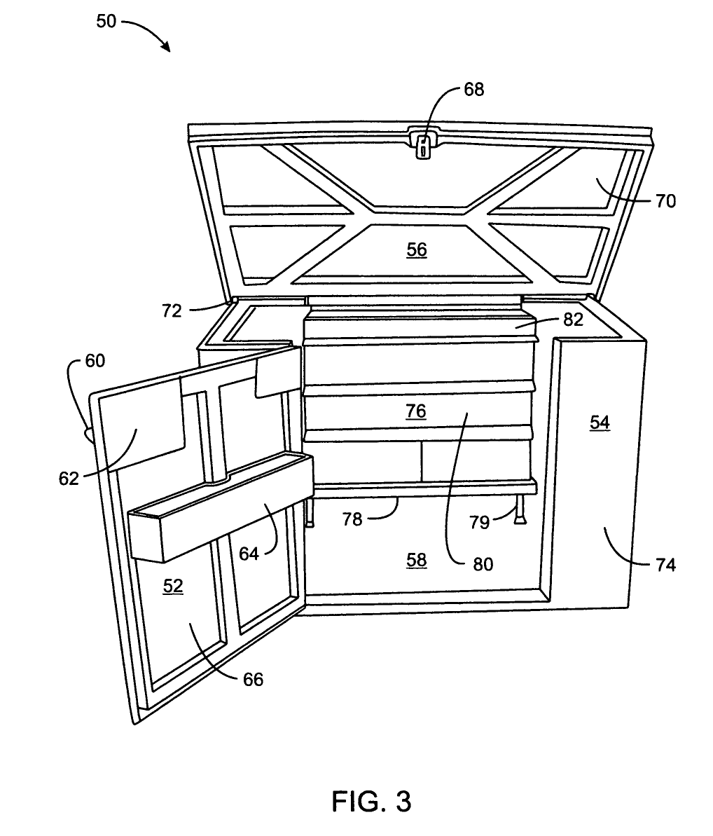

FIG. 3 is a toolbox 50 similar to the toolbox 10 of FIGS. 1-2. The toolbox 50 has a substantially-centered front door 52, a front 54, a top or lid 56, and an interior 58. The front door 52 has a handle 60, and a plate 62 supporting the handle 60. A shelf or bin 64 is disposed on an interior surface of the door 52. The substantially-centered front door 52 is situated on the front 54 between the front sides 74, behind which may be placed internals such as shelves, bins, and so forth.

The lid 56 may have a lock element 68 and accessories such as lighting (not shown) or other features positioned on an interior surface 70 of the lid. The lid 56 and upper portion of the toolbox 50 may have hinges and/or air shocks (not shown), or other elements to facilitate maintaining the lid 56 in an open position. Various internals may be disposed in the interior 58 of the toolbox 52. Such externals may include an interior smaller toolbox 76 within the overall larger toolbox 52. The interior toolbox 76 may be supported by a support, 78 such as a plate, bench, etc. (e.g., having legs 79). The support 78 may include one, two, three, or more horizontal flat pieces. The interior toolbox 76 may have drawers 80 and an upper shelf 82, for example.

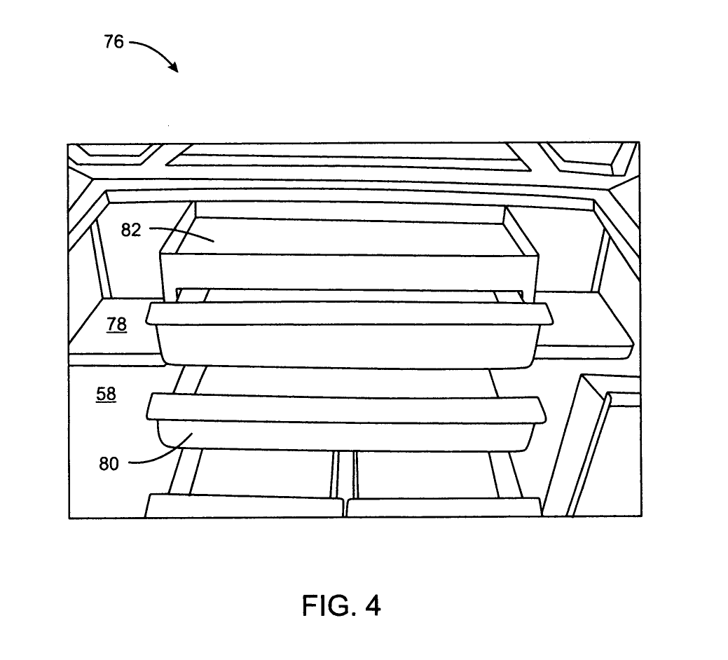

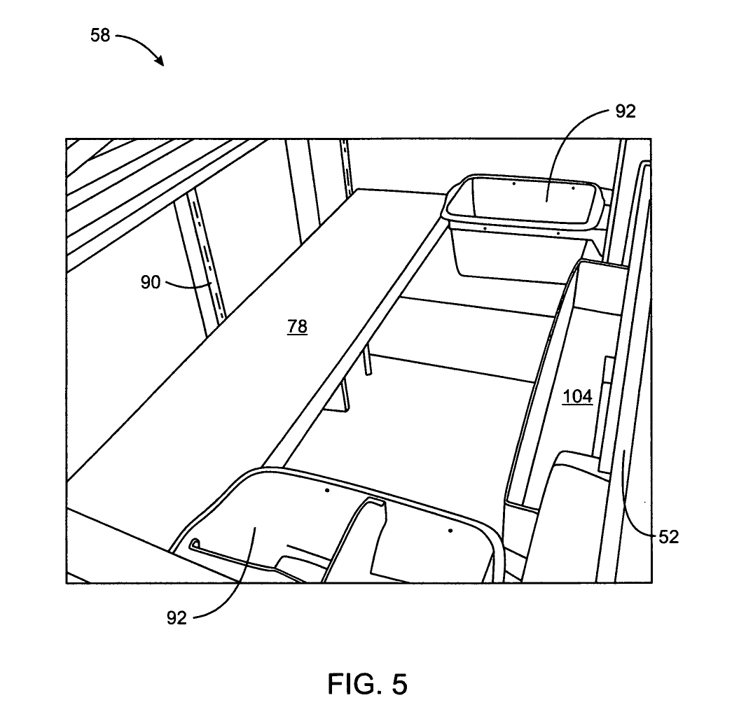

FIG. 4 is a closer view of the interior toolbox 76 disposed in the interior 58 of the toolbox 50. FIG. 5 is the interior 58 without the toolbox 76. The support 78 remains as a shelf 78, and an adjustable bracket 100 holds the shelf 78 in the desire position and/or elevation. Also disposed in the interior 58 of the toolbox 50 are bins 102 on each side of the door 52.

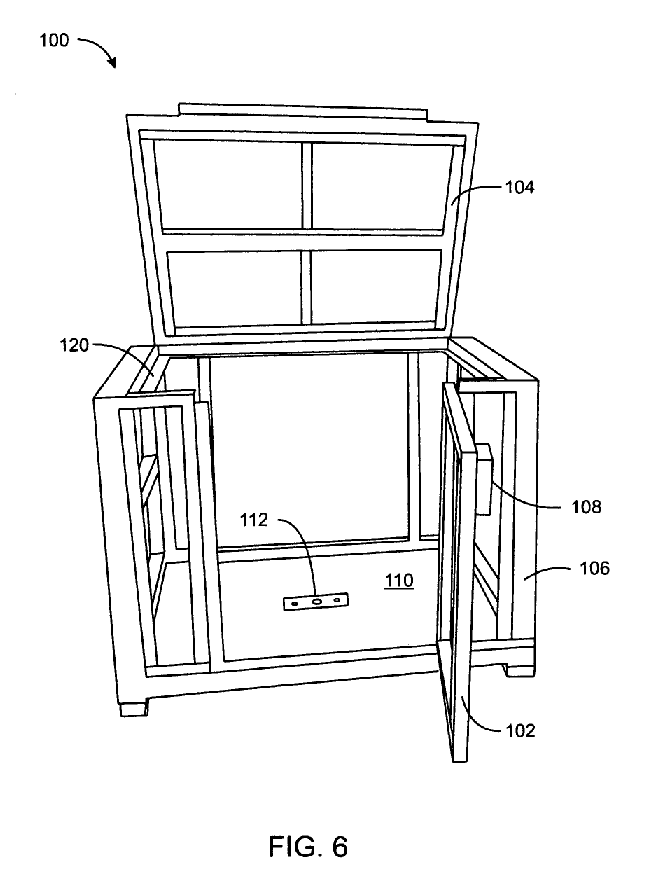

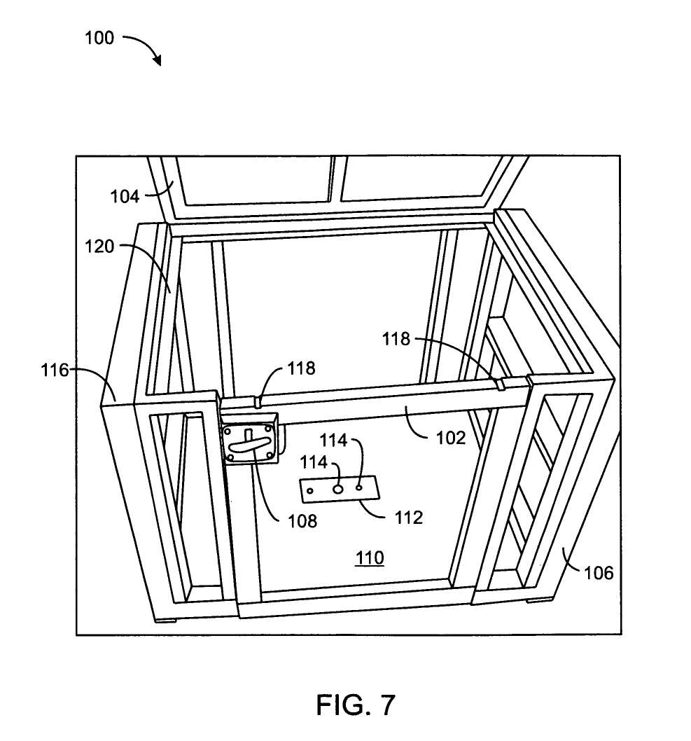

FIG. 6 (opened door) and FIG. 7 (closed door) are another exemplary toolbox 100. The toolbox 100 is depicted prior to completed construction without the outside panels (e.g., sheet metal) to better illustrate the underlying support frames. The toolbox 100 has door frame 102, lid frame 104, and body frame 106. The body frame 106 may include various pieces and frames welded, riveted, or otherwise assembled together. The body frame 106 may include assemblies of a floor frame, side frames, front side frames, and a back frame, for example. In the illustrated embodiment, a handle 108 is installed on the door frame 102. Elements of the handle 108 may interact with the body frame 106 and/or the lid frame 104.

A panel 110 is installed on the bottom floor frame of the body frame 106. A plate 112 having openings 114 is installed on the panel 110 to facilitate, for example, securing the toolbox to a surface below the toolbox 100. In this example, lifting elements (not shown), such as rings, d-rings, etc., may be installed at the upper corners 116 of the body frame 116. Before or after exterior panels (e.g., sheet metal) is installed. Indentations 118 on the upper surface of the door frame 1002 may receive the lid frame 104. Lastly, a recessed area 120 in an upper portion of the body frame 106 may receive the lid frame 104. In this example, the lid frame 104 does not extend all the way to the sides. It should be noted, that the recess area 120 for receiving the lid does not exist in other eb-mbodiments.

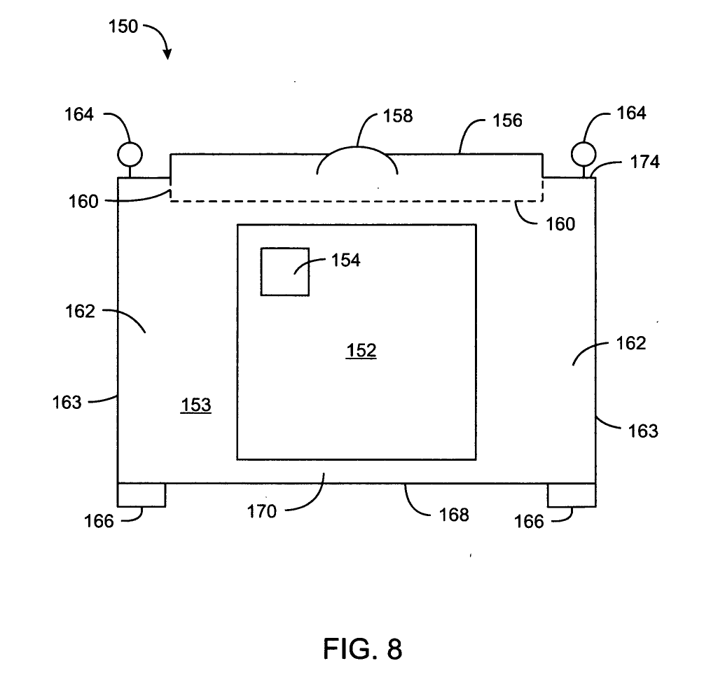

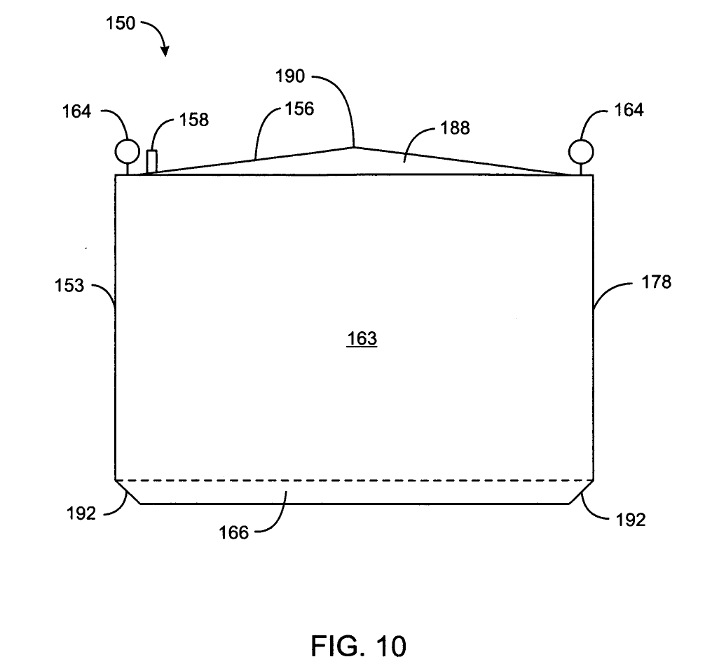

FIGS. 8-10 are a front view, top view, and side view, respectively, of a completed toolbox 150 having exterior panels (e.g., sheet metal) installed. The completed toolbox 150 may be based at least in part on the toolbox frames of FIGS. 6-7. The toolbox 150 has a door 152 substantially centered in the front 153 of the toolbox 150. The door is 152 is at least 2 feet by at least 2 feet, at least 2.5 feet by at least 2.5 feet, at least 3 feet by at least 3 feet, or at least 4 feet by at least 4 feet, or any combination thereof, and so forth. The height and width of the door may be the same length or different lengths. The door 152 has a handle 154.

The toolbox 150 has a lid 156 having a handle 158. The lid 150 (in the closed position) rests in an interface recess area 160 of the upper portion of the front sides 162. Also, notably the lid 156 does not extend to the actual sides 163 in this example. Further, in this example, a door threshold 170 on the bottom portion of the toolbox 150 interfaces with the door 152.

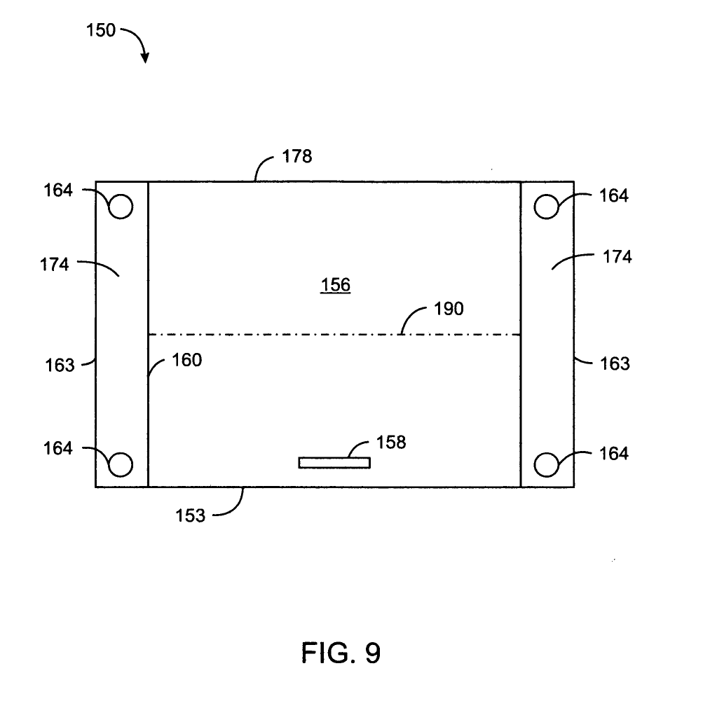

Lifting elements 164 and skids 166 may be provided to facilitate lifting, moving, or sliding, and so on, of the toolbox 150. In the illustrated embodiment, the lifting elements 164 are positioned near the corners of the top surface 174 of the toolbox 150. The lifting elements 164 may include lugs, rings, d-rings, clamps, and/or hooks, and so on. The skids 166 are disposed on the bottom 168 of the toolbox 150. The skids 166 may be configured to receive a tongue of a fork truck, for example. Moreover, it is noted that the back of the toolbox 150 is denoted in FIGS. 8 and 9 by the reference numeral 178.

To facilitate stacking of the toolboxes 150, a gable 188 having a peak 190 is provided. The gable 188 on top of the lid 156 may provide a securing interface with the bottom of another toolbox 150. Further, a cavity 192 at the bottom four corners of a toolbox 150 provides a resting place for the lifting elements 164 on the top of another mating stacked toolbox 150.

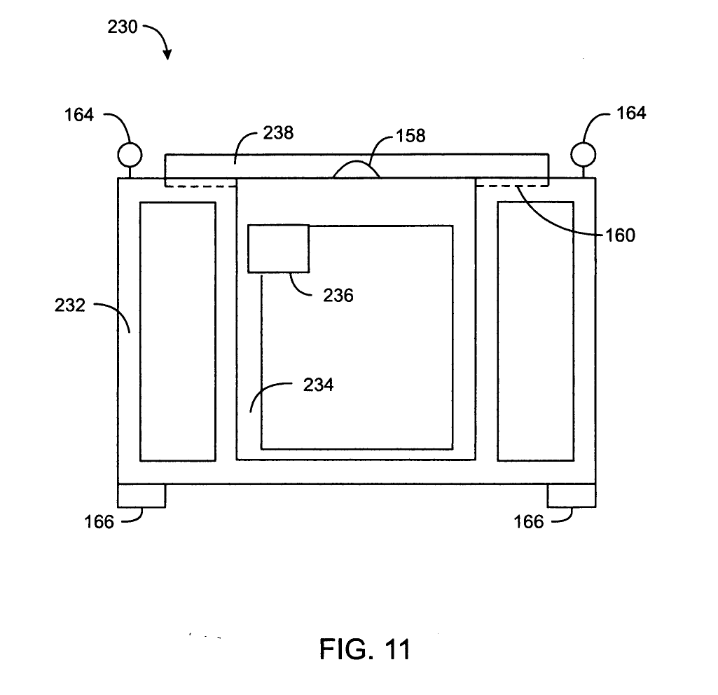

FIG. 11 is a simplified front view of toolbox 230 not yet having exterior panels installed, so to better illustrate the underlying support frames. The frames include a body frame 232, door frame 234, and lid frame 238. The body frame 232 may include a plurality of frames, sub-frames, or components assembled (e.g., welded, fastened, etc.) together. In the illustrate embodiment, a plate 236 is installed on the door frame 234 to support a door handle. Further, a handle 158 is installed on the lid frame 238. The lid handle 158 may be installed before or after the installation of exterior panels. The interface 160 of the lid frame 238 with the body frame 232 is denoted by a dotted line and the reference numeral 160. Lastly, lifting elements 164 and skids 166 are shown attached to the body frame 232.

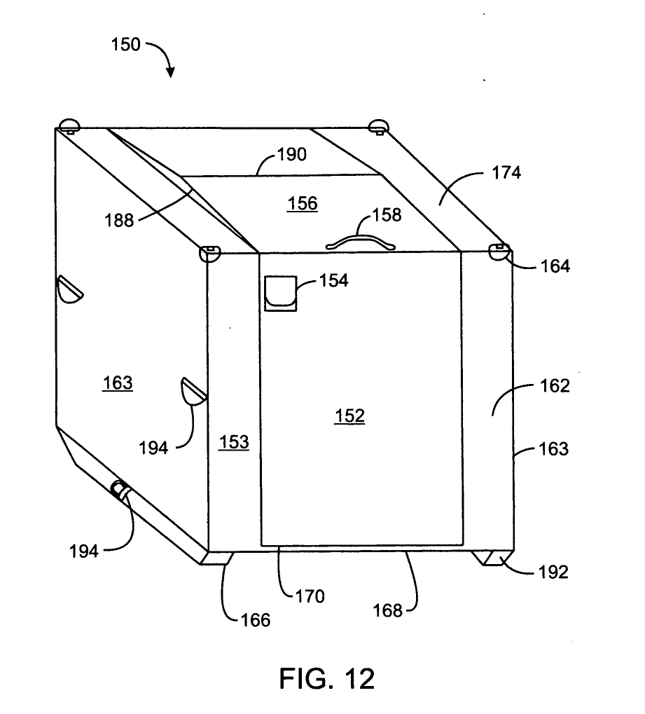

FIG. 12 is a perspective view of a toolbox 150 which may be similar to the toolbox 150 of FIGS. 8-10. As discussed, the toolbox 150 has a front 153, sides 163, a bottom 168, and a top 174. The toolbox 150 has a substantially-centered front door 152 and a lid 156. The door 152 is situated between the front sides 162 and, as mentioned, may be at least 2 feet by at least 2 feet, at least 2.5 feet by at least 2.5 feet, at least 3 feet by at least 3 feet, or at least 4 feet by at least 4 feet, or any height/width combinations thereof, and so forth. In the illustrated embodiment, a door handle 154 has a flat lever that may be lifted to open the door 152. The door handle 154 may interface or engage the front sides 162, the lid 156, etc. to provide for securing of the door 152 in the closed position, and to provide for release of the door from the closed position to an opened position. As discussed, the lid 156 has a handle 158. In this example, the lid 156 does not extend to the actual sides 163. Further, in this example, a door threshold 170 on the bottom portion of the toolbox 150 interfaces with the door 152.

Lifting elements 164 and skids 166 may facilitate lifting of the toolbox 150. In the illustrated embodiment, the lifting elements 164 are positioned near the corners of the top 174 of the toolbox 150. The lifting elements 164 may include lugs, rings, d-rings, clamps, and/or hooks, and so on. The skids 166 are disposed on the bottom 168 of the toolbox 150. As indicated, the skids 166 may be configured to receive a tongue of a fork truck o rother lifting device, for example. To facilitate stacking of the toolboxes 150, a gable 188 having a peak 190 is provided. The gable 188 on top of the lid 156 may provide a securing interface with the bottom of another toolbox 150. Further, a cavity 192 at the bottom four corners of a toolbox 150 provides a gap for the lifting elements 164 on the top of another mating stacked toolbox 150. Lastly, lifting or pulling elements 194, such as rings, hooks, d-rings, clamps, and so on, may be provided on the sides 163 of the toolbox in addition or in lieu of the lifting elements 164 (on the top 174). However, as discussed below, lifting elements 264 (e.g., d-rings) may facilitate securing of a stacked configuration of toolboxes 150 by interfacing with the bottom of another toolbox 150.

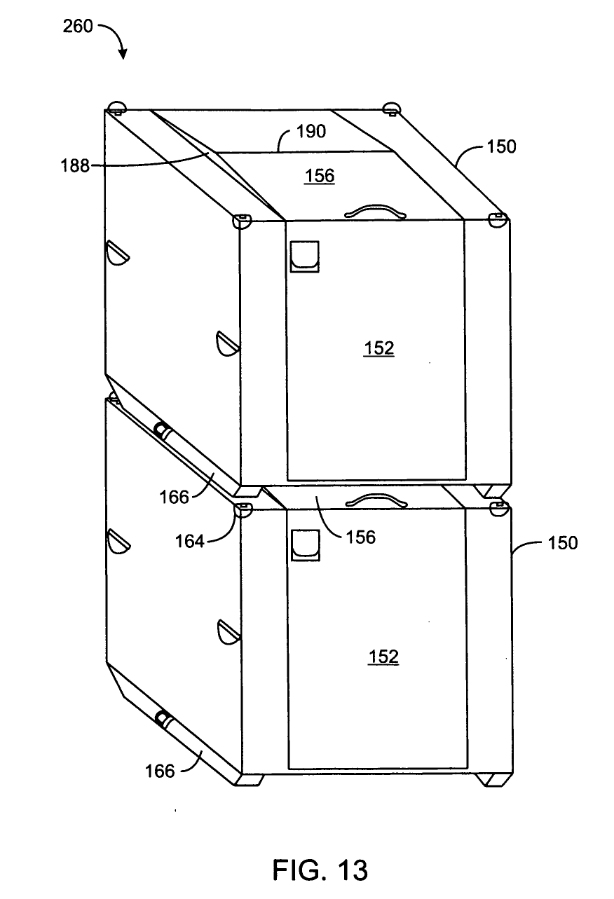

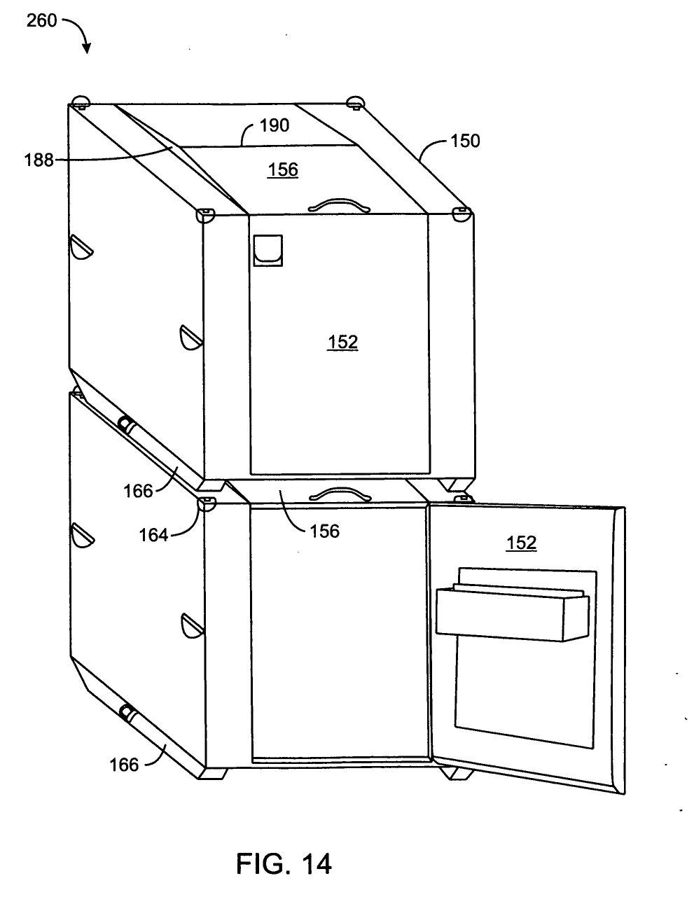

FIGS. 13 and 14 show a stack configuration 260 of two toolboxes 150. In FIG. 13, the doors 152 of the toolboxes 150 are in the closed position. In FIG. 14, the door 152 of the top toolbox 150 is in the closed position, and the door 152 of bottom toolbox 150 is in an opened position. Thus, as indicated in the illustrated embodiment, the doors 152 may be opened to beneficially provide access to the interior of the toolbox 152 when the toolbox 152 is in a stacked configuration 260.

Advantageously, features of the toolboxes 150 may provide for securing or stabilizing the toolboxes 150 in the stacked configuration 260. For example, in the stacked configuration 260, the skids 166 (or skid components) of the top toolbox 150 rest on each side of the gable 188 of the bottom toolbox to stabilize movement of the toolboxes 150 from side-to-side motion. In another example, in the stacked configuration 260, lifting elements 164 of the bottom toolbox 150 reside in a cavity 192 on the bottom of the top toolbox 150. The engagement between the skids 166 on the top toolbox 150 with the lifting elements 164 on the bottom toolbox 150 stabilizes movement of the toolboxes from front-to-back motion. The skid components 166 and the lifting elements 144 each provide a dual function of: (1) facilitating lifting, moving, or sliding of the toolbox 150; and (2) facilitating securing and/or stabilization of the toolbox 150 in a stacked configuration (with a second toolbox 150 or more).

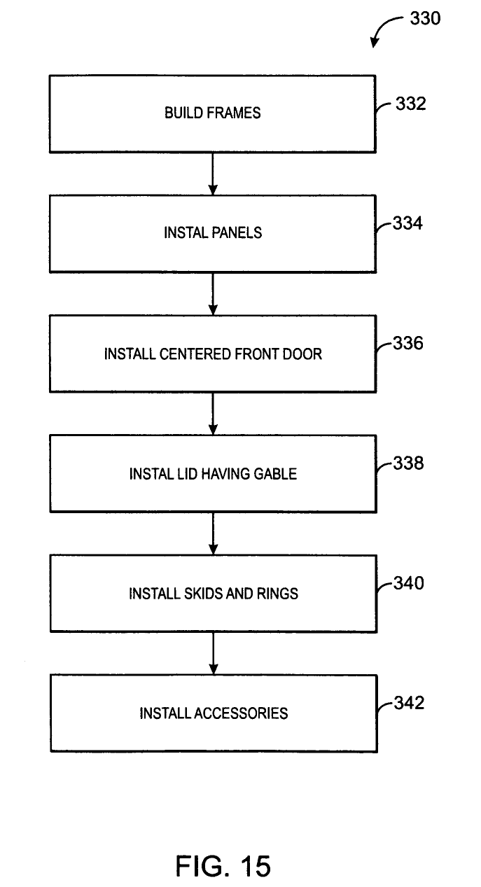

FIG. 15 is a method 330 for fabricating a toolbox (e.g., 150) in accordance with embodiments of the present techniques. Various frames, such as a body frame, door frame, and lid frame, are constructed/built (block 332). Panels, such as sheet metal, plastic or fiberglass siding, etc., are installed (block 334) on the frames. The front door is installed (block 336) substantially centered in the front of the toolbox. The lid, which has a gable to facilitate stability in a stacked configuration, is installed (block 338). Skids and lifting rings, which facilitate lifting as well as provide for stability in a stacked configuration, are installed (block 340). The skids are installed on the bottom of the toolbox and the lifting rings are installed on top of the toolbox. Lastly, various accessories may be installed (block 342) in or on the toolbox. Accessories may include lighting (such as on the interior of the lid), support elements to facilitate maintaining the lid in an open position, electrical wiring, and so forth.

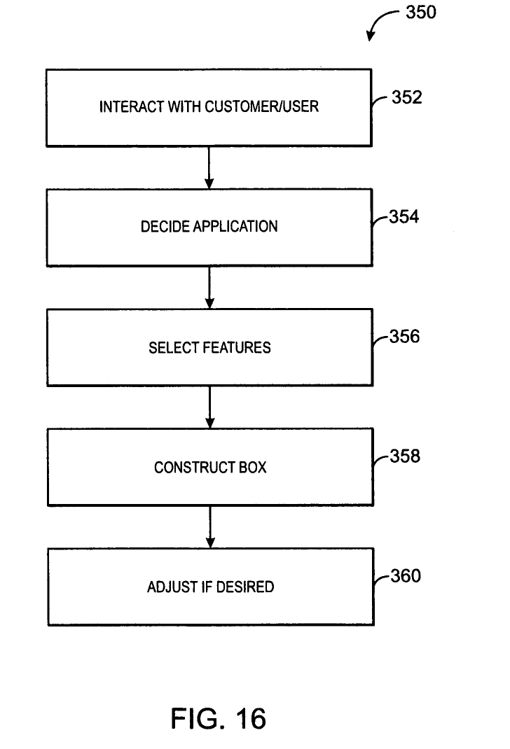

FIG. 16 depicts a method 350 for customizing a toolbox. Initially the customer or user is consulted (block 352). The interaction may be in various ways, such as in person, by phone, online (e.g., through email or website interactive data entry forms, website pull-down menus, etc.), and so on. In such interaction the desired application of the box is communicated, defined, and decided (block 354). Moreover, it should be noted that the customization may begin with a category of a box as a basis, such as a standard box or a heavy-duty box, and so on. Further, the various available features may be listed, described, and chosen (block 356). Such features may be selected, in part, based on the desired application of the box for example. Subsequently, the customized box may be constructed (block 358). It should be noted that in certain embodiments, the customized box may be further adjustable post-construction, such as in the movement or removal of boxes, shelves, bracing, and so forth (block 360).

Customizing the container or box (e.g., brand name LRBBOX of Shepherd, Tex. USA) may include placing bins, shelving, hangers, electrical plugs, lighting, or reinforcement tailored to the objective at hand. Commercial trades such as plumbing, electricians, pipe fitters, oilfield and pipeline jobs could set their box to suit there needs. Mechanics of all types could house their tools appropriately. The centered door facilitates access to the portfolio of equipment within. Organization is advantageous and the box of the present techniques provides unique effective options. Beneficial features include but are not limited to dual access with lid and at least a 2 feet (or 3 feet and greater) front door with midway access, adjustable shelving & bins, lightweight and durable. In certain examples, an additional feature may include stack ability as the top of the box may be level across without a slanted pitch giving the ability to stack these storage containers on top of each other while still allowing front door access. In other embodiments, as discussed above, the lid may have a gable to facilitate situating and/or securing of one toolbox stacked with the other toolbox.

The present techniques provide a method of constructing a toolbox including: interacting with a customer; specifying a desired application of the box via the interaction; selecting features to accommodate the application via the interaction; and constructing the box per the application and the selected features. Interacting with the customer may include interacting with the customer in person, by phone, or electronically online, or any combination thereof. The interaction with the custom may be electronically online including interacting through email, a website interactive data entry form, or a website pull-down menu, or any combination thereof; The exemplary method may include adjusting the box post-construction. Such adjusting may include relocating or removing a shelf or a bin of the box, or any combination thereof, for example.

In sum, the present techniques may provide a toolbox including: a body configured to receive casters on a bottom portion of the body, wherein the casters comprise wheels that facilitate movement or relocation of the toolbox; a lid coupled to the body, the lid comprising a raised portion on a top exterior surface of the lid to facilitate stabilization of the toolbox in a stacked configuration with a second toolbox; a front door coupled to the body and substantially centered in a front side of the toolbox, wherein the front door is at least 2 feet by at least 2 feet in size, and wherein the front door and the lid provide for multi-access to an interior of the toolbox, and wherein an enclosure of the toolbox is formed by a combination of the body, the lid in a closed position, and the front door in a closed position; lifting elements coupled to an upper portion of the body on each side of the lid to facilitate lifting of the toolbox and also to facilitate stabilization of the toolbox in the stacked configuration; and skid components coupled to a lower portion of the body to facilitate lifting of the toolbox and also to facilitate stabilization of the toolbox in the stacked configuration.

The present techniques may also provide a method of manufacturing a toolbox, the method including: constructing a body frame, a door frame, and a lid frame; installing panels on the body frame, the door frame, and the lid frame to form a body, a door, and a lid, respectively, wherein the lid comprises a gable configured to facilitate stability of the toolbox in a stacked configuration with another toolbox; installing a lid handle on the lid and a door handle on the door; coupling the door substantially centered to a front of the body; coupling the lid to an upper portion of the body; coupling lifting elements on an upper portion of the body, wherein the lifting elements facilitate lifting of the toolbox, and also facilitate stability of the toolbox in the stacked configuration; and coupling skid components on a lower portion of the body, wherein the skid components facilitate lifting of the toolbox, and also facilitate stability of the toolbox in the stacked configuration.

Further, the present techniques may provide a stacked configuration including a first toolbox and a second toolbox stacked on top of the first toolbox, wherein the first toolbox and the second toolbox each comprise: a body; a lid coupled to the body, the lid comprising a raised portion on a top exterior surface of the lid; a front door coupled to the body and substantially centered in a front side the body, wherein the front door is at least 2 feet by at least 2 feet in size, and wherein the front door and the lid provide for multi-access to an interior of the body, and wherein an enclosure is formed by a combination of the body, the lid in a closed position, and the front door in a closed position; lifting elements coupled to an upper portion of the body on each side of the lid to facilitate lifting; and skid components coupled to a lower portion of the body to facilitate lifting. Further, the lifting elements of the second toolbox engage the skid components of the first toolbox to reduce front-to-back motion and back-to front motion of the first toolbox with respect to the second toolbox and of the second toolbox with respect to the first toolbox. In addition, the raised portion of the lid of the second toolbox engages the skid components of the first toolbox to reduce side-to-side motion of the first toolbox with respect to the second toolbox and of the second toolbox with respect to the first toolbox.

In general, whether standard or customized, the present techniques may include the following various features. The toolbox can be lifted several ways, from top, bottom while loaded and using the side handles if the box is empty. Due to the skids installed this allows the box to be lifted from the bottom and when two or more boxes are stacked on top of each other the skids prevent the top box from sliding off the side and due to the lifting D-rings on all four top corners the skids prevent the box from sliding off the front or back thus interlocking. When stacked on top of each other the toolbox may still gives access inside the box through the front door. Compartments and a writing surface shelf can be installed on the bottom side of the lid inside in which it can be opened up for use. Adjustable shelving inside the box facilitates organization and, also, having the use of the front walls on each side of the door give more options. Light weight lifting handles can be installed for each side. Towing rings (e.g., d-rings) may be installed to the floor frame underneath the front and back of the box to assist in moving the box using the skids. Casters can be used for easy mobility and towing D-rings can also be installed on the sides to also assist in mobility. Lighting with a switch and including automatic lighting may-be installed with a switch. From the inside, access through the frame (tubes) can be given for attaching and lock down to the outside.

### FABRICATION EXAMPLE 1

Example 1 is given only as a specific example of the present techniques and not meant to limit the present techniques. With certain features, Example 1 may generally correlate with toolbox 150 of FIG. 12. Exemplary material used with this Example 1 includes 20 gauge galvanized (Paint Drop Ready) sheet metal; 4′×10′ Sheet Metal; Steel ⅛″ Rivets 3/16″ Head Steel ⅛″ Rivets ¼″ Head and Weld Wire for attaching purposes; (Qty1) Lock Clasp; (Qty1) Lid Lift Handle; (Qty4) Side; handles for lifting; (8 ft) Stainless Steel Continuous Hinge; (Qty4) Top Lifting D-Rings; Side and Front towing D-Rings; (Qty1) Locking Paddle Handle; (Qty2) Flat bars; (Qty1) Square tube; (Qty2) Pulleys; (Qty2) Eye Bolts with nuts; (Qty1) Chain Link; Cable with (Qty2) crimps.

Frame Assembly

The assemblies are attached by weld, rivets, or glue, or any combination:

1) Framing track used in this example is 18 gage 2⅝″ Track with 1′ lips. Two tracks inserted together are utilized to create an enclosed tube affect.

2) Cut-offs are a certain length of track that is cut-off and used accordingly.

3) Stripping Track: Means Cutting the 2⅝″ side of the track resulting in two separate 90° angle pieces referenced as Angle Sides. Sizes and lengths can vary.

4) A Half-Tube is two Angle Sides assembled together in the form of a square tube usually. welded.

FLOOR FRAME. Each tube is horizontally assembled. Start by measuring and cutting all four sides of the bottom tube track for the box dimensions desired. The front and back will be the same length as both sides will also be the same length.

Front Tube: will be built to include the threshold for the door. Therefore to get the threshold width first take the bottom track now already cut to size and multiply the length times (0.6) to get the width of the door. Now to find center for the threshold, subtract the width of the door by the length of the front track, divide by 2 and then add ¼″ giving the length measured for each side of the track. Mark this length from each end on the lip of the track facing the outside for both sides thus giving the centered threshold in between the marks. Now center strip another track the same length of the threshold (The distance between the marks on the front bottom track) and position one of the angle sides towards the back lip of the bottom track with the angle facing out giving half of the track the tube affect and tack weld in place. Place the other angle side inside the front bottom track upside down with the angle down. Cut the lip on the outside front bottom track on both sides that was marked for the threshold and fold the lip down towards the inside and tack-weld. On each side of the threshold measure from that point to the outside of the side wall and subtract 1¼″, then cut (Qty2) tracks that length. Now cut out one corner of each track 2⅝″ long from end X 1¼″ wide from center and then insert the remaining track with the cut-out facing towards the outside corner flush of each side giving the tube affect for both ends and also allowing for the wall tubes to properly be able to set inside on both ends of the floor tube.

Back Tube: Cut a track the same length of the bottom back track previously cut which is the same length as the front track and then cut-out the corner of each end on the same side 2⅝″ long X 1¼″ wide from center. Insert the track into the bottom back track with the cut-outs facing both outside corners.

Side Tubes: Now cut (Qty2) top tracks the same length as the bottom side tracks already previously cut and assemble the tubes. Then fit and weld each side-tube square, horizontal and flush to the front and back tubes at each end thus giving the outside floor frame a rectangle perimeter.

Middle Tube: Measure inside to inside front to back at the center location and cut and assemble the two tracks for the centered tube. Now fit and weld the center tube to the front and back tubes with the same orientation as the rest of the floor frame, horizontal flush. Next to build are the side walls for installation.

Sheet Metal Floor: Cut the sheet metal for the floor the size of the surface area l×W, then cut out the holes for the vertical tubes and attach the sheet metal securely with rivets and or weld. Now cut the sheet metal on each side of the door threshold and bend the lip downwards and attach with rivets and or weld to the floor tube.

Building and installing the Skids: Measure and cut (Qty8) Tracks for two skids the length of the depth of the box from front to back. Insert them to make tubes and stack (Qty2) on top of each other. Make a mark at 3″ on the side of the top track and mark a straight line back down to the end of the bottom track. Mark and cut both ends with this angle and cap the openings with the cut material and weld. Now position each skid with the longer side flush to the outside edge on each side at the bottom of the floor and weld securely.

Sidewall Frames

Vertical Wall Tubes: Measure and cut (Qty4) tracks the same size for desired height of the box. Then take and subtract 8″ from the length of the first four tracks and cut (Qty4) more tracks that length. Now join one of each track as a tube leaving 4″ on each end open. Make (Qty4) 2¾″ cut-offs and insert upside down on each open end of the four vertical tubes leaving the 1¼″ space on the ends and weld. Now insert the vertical tubes into the floor at each corner with the upside down cut-offs facing towards the inside at the top of the wall. Now level and weld all of the way around each vertical tube at the bottom to the floor tubes. Top-Side Wall Tubes: Measure the outside to outside length from front to back for each side and cut both top-side tracks that length. Then make (Qty4) 2¾″ cut-offs, for each end of top-side track then insert upside down also leaving the 1¼″ space from the end and weld. Now measure the remaining inside space from one end of cut-off to the other cut-off and cut a track that length for the bottom-side and join to complete the tube. Now position and fit both top side tubes over the top of each front to back vertical tube down flush and weld both sides.

Mid-wall bracing: At center height measure inside to inside of the vertical tubes from front to back and cut (Qty2) tracks to make a tube, one tube for each side wall. Note that the bracing tube is at center height and turned vertically flush to the outside of the wall and welded to the vertical tubes all of the way around at both sides.

Front Wall Frames

Vertical Front Wall Tubes: Measure and cut four tracks the same size as the outside vertical tracks which is the height of the box and join to make (Qty2) vertical tubes one for the left side and one for the right side next to the door threshold. Fit each tube in both allotted slots already in the floor tube positioning the 1″ lip toward the front outside of the box flush and level just as the slots allow. Now weld the vertical tube to the floor tube all of the way around.

Top Front Wall Tubes: Measure from the outside of the vertical tube at the threshold butted up to the inside of the top-tube of the side wall and cut two tracks for each top-track of both front walls that length. Fit the top track over the vertical tube at the threshold and butt the other side flush to the sidewall tubes and weld in place. Now measure the length from the inside of the vertical tube at the threshold to the inside of the vertical tube of the sidewall and cut one for each front wall top track to complete the top-tubes of both front wall frames.

DOOR FRAME; Measure the width of the threshold from inside of both front wall vertical tubes subtract ½″ and cut (Qty4) tracks this length to make the top and bottom tubes for the door frame. Measure the total height of the box frame and subtract 5½″ and cut (Qty4) tracks that length for both side tubes of the door frame. Put together vertically one track for each top, bottom and both sides and assemble as the door frame with the lips facing the same direction flush and weld together. Now install the latching components inside door frame before completing the door frame tubes.

### Lid Latching Component:

Measure and cut a ½″ gap of the top lip out starting at the 4″ mark from an end of the top track this will be the side with the handle installed. Also cut out 1″ down the back side of the track with the same ½″ gap. From the other end cut a ½″ gap of the top lip out starting at the 3″ mark and also cut out 1″ down the back side of the track with a ¼″ gap. Then mark 1″ from the edge of the top track and insert inside the track a 2⅝″ angle side down across from lip to lip of the track and weld. Now measure from the lip of the angle side over the ½″ gap closest to the handle at the 4″ mark and add 1″ to that measurement. Cut the flat bar this length. Position the flat bar all of the way against the cross angle side in the track and mark the ½″ gaps on the flat bar and cut the latching shape out of the flat bar. Now cut the 1″ square tube 4″ shorter than the flat bar length and measure and mark on the same corner 2″ from one end of the square tube and measure and mark 1″ from the other end. Cut both marks on the corner with the same ½″ gap X 1″ down thus lining up with the top-lip ½″ gaps and position in diagonal fashion so the flat bar will be straight up and down and weld the square tube in place to the track. Insert the flat bar into the square tube with shaft first butting it up to the cross angle side. The two latching areas on the flat bar should be lined up with the two ¼″ gaps. Now Drill a hole on the flat bar at the shaft so that the spring can hook and drill another hole on the cross angle side lip lined up to hook the other end of the spring, hook the spring.

### Bottom Latching Chain Bolt:

At the bottom track corner on the handle side, measure ½″ from the bottom and 1″ from the side giving the center of a 1¼″ horizontal long X ½″ wide rectangle whole to be cut out of the track. Now cut out the top-lip of the bottom track directly above the hole the same 1¼″ size and position the chain bolt with the stem upward and the angle of the bolt lined up center ways with the 1¼″ hole in the track, then mark and attach the chain bolt securely.

Locking Handle Frame: This handle is mounted in the top inside corner of the side tube attached to the top-tube of the door frame. Now take and cut (Qty3) 3″ tracks and split all of the tracks giving six 3″ angle sides. In the corner of the inside lip on the side track attached to the top tube measure 4″ down and cut the lip out. At the 4″ mark on the side track where the lip was cut out, position and weld (Qty1) 3″ angle side, with the angle facing down and outside centered to the lip of the side track as this will be the part of the bottom side handle frame. There should now be 1½″ of the angle side inside the track and the other 1½″ on the outside of the side track. Take another 3″ angle side and weld it to the end of the 1½″ side outside of the track up to the top-tube also with angle down facing outside. Next perform the following before finishing the handle frame.

Installing Pulleys: Now cut out the top track inside lip at both sides where it meets with the side track with the handle. Measure from the outside lip of top track 1½″ down X 1″ from the edge of side and install (Qty1) pulley now measure from the outside lip of top track 1½″ down X 3″ from the edge of side and install the other (Qty1) pulley.

Installing the cable to the Lid Latch: First drill a hole in the flat bar near the bottom corner closest to the handle for the cable to fit through. Then measure the distance from the hole to the center of the pulley and add 4″ giving the length to cut the cable. Now run the cable through the hole on the flat-bar and attach it to itself using a crimp.

Installing the connecting cable to the Bottom Door Chain Bolt: Measure the distance from the eye of the chain bolt up to the center of the pulley and add 4″ for the length of the cable to be cut. Run the cable through the chain bolt eye and attach it to itself using a crimp.

Finishing the Handle Frame: The 3″ frame handle consist of three front and back-sides. Therefore inside the side-track where the previously installed center back-side frame ends position the last 3″ back-side by attaching one end to make the corner and the other end up toward the top track square also with angle down facing outside and weld in place. Now take the remaining (Qty3) 3″ angle sides previously cut and position each by lapping inside one side of the front side angle with the lip of the back-side angle. The front side angle should be upward and facing outside. Now weld all three front sides to the back sides. Completing the Door Frame Tubes: Using the remaining previously cut top, bottom, and side door tracks take the top track and cut the ½″ gaps only out of the lip for the lid latch and slot the lip for the cross side angle in the track. Make sure the cable is run through the pulley and accessible at the top of handle frame and then insert the track to complete the tube. For the side track with the handle, cut out according to the handle frame and insert to complete the tube making sure the cable attached to the chain bolt is run through the pulley and accessible at the top of the handle frame. Now take the other side track and insert to complete the tube. The bottom track will need the top lip cut out for the chain bolt and then insert the track to complete the tube.

Both Side Half Tube Thresholds for the Door:

Measure from the inside bottom floor up to the bottom of the front wall top-tube and cut a track that length and then center strip the track. Now put the two strips together to make a half tube and weld together. Now position the threshold half tube next to the vertical front wall tube to the backside flush and weld in place. Cut a piece of track to cap off the exposed end on top and weld. Do both sides the same way.

Complete Installing the Door:

Now cut and weld the hinge on the outside edge of the door opposite the handle and then position and weld the other side of the hinge on to the outside of the front wall vertical tube thus setting the door with a ⅛″ on the sides and flush with the top of the front walls. Now install the chain link ½″×½″ off of the edge and bottom into the corner of the floor threshold under the handle where the chain-bolt latches and weld. Now take the sheet metal and cut it the same size as the face of the door plus 1″ for the width and plus 2″ for the height. Then make three 1″ 90 degree bends one on the side, one on the top and one on the bottom of the sheet metal. Now cut out the 3″ square for the handle frame and install the sheet metal with rivets on to the outside face of the door placing the 1″ bend on the side of the door with the handle. Now install the Locking Paddle handle using rivets and weld for security. Now access the door from the backside and attach the two cables to the handle arm using the crimps.

Side Wall Top Frame for Lid

Horizontal Tube: For both sides measure from the inside of the front wall top-tube to the outside of the back corner vertical tube of the side wall and make a full tube that length. Now position the tube next to the sidewall top-tube horizontal flush and weld in place giving a frame for the lid to set and seal at both sides.

Back Wall Lid Threshold Frame

Horizontal Half Tube Threshold: Measure from inside of the side lid frame to the other inside of lid frame attached to the side walls and cut two tracks that length. Take the bottom track and bend over the inside lip towards toward the inside. Next center split the other track and position one of the angle sides towards the back outside lip of the bottom track with the corner facing out giving the track the half tube affect and weld in place. Take the lid threshold and position between the two sidewall lid frames at the top back flush with outside and weld in place. To add a center brace measure from the bottom of the back wall lid threshold down to the floor and cut two tracks that length to make a tube. Install the tube with the 2⅝″ side flush to the back frame and weld in place.

Lid Frame

Note that the complete perimeter of the frame is a half tube with a lip and is built the same except for the front part that sets on top of the threshold and up close to the door providing the eye bolts used for locking the lid.

Back Side Lid Half Tube Frame: Measure from side to side on the inside of the wall lid frame and strip two tracks that length. Take two of the angle sides and weld together as a half tube. Take one more angle side and position it flush up against the half tube with the angle up so that one side of the angle side makes an outside lip and weld together.

Side Lid Half Tube Frame:

Measure the length from the inside edge back wall Lid threshold to the inside front wall top tube, subtract ½″ and make (Qty3) Angle Sides that length. Take two of the angle sides and weld together as a half tube. Take one more angle side and position it flush up against the half tube with the angle up so that one side of the angle side makes an outside lip and weld together. Do this for both sides of the lid and weld to the back lid frame inside flush on the ends keeping the two back corners square.

Front Lid Frame:

Measure from the side wall lid frame to the front wall vertical threshold tube on the outside, subtract 1″ and make (Qty3) Angle Sides that length. Take two of the angle sides and weld together as a half tube. Take one more angle side and position it flush up against the half tube with the angle up so that one side of the angle side makes an outside lip and weld together. Do this for both sides for the front of the lid and weld to the side lid half tube frames inside flush on the ends keeping the two front corners square. Now measure the threshold width from inside to inside of the front vertical tubes and make a full tube this length. Then attach one 2⅝″ long Angle Side on each end of the full tube with the angle up and flush so that one side of the Angle Side makes an outside lip. Now cut (Qty1) Angle Side the same length as the full tube and position it flush up against the front side of full tube so that one side of the angle side makes an outside lip and weld together. Next take the full tube and position at backside of both sides and flush with the backside of the front lid half tubes on each side and weld together using the outside lips as the corners to interlock for more stability.

Gable Tube Lid Frame:

The purpose of this frame is to provide an angled surface of the Lid for precipitation run-off. Using the 2⅝″ side of the track to cut the angle the highest point should be approximate ⅓″ to every foot. Example: 3′ deep box gets a 1″ Gable Frame. Cut the track the length of the depth of the box and mark the center using the 3′:1″ ratio for the highest point. Mark and cut from the lowest point at both ends of the track towards the highest point. Cut a total of (Qty6) tracks this way and put two together to make the Gable Tube and weld. Place one on top of the lid half tube frame from front to back at each end flush with the sides and the other front to back in the center flush and weld securely. Now measure the inside from one of the Gable Tubes on the end to the inside of the Center Gable Tube and cut a track that length and position from side to side to where each side of the corners of the track is flush with the top of each Gable Tube on each side of the peak and weld. Do the other side the same way.

Installing Continuous Hinge and Cutting the Sheet Metal for the Lid:

Cut the continuous hinge the length of the Back Side Lid Half Tube Frame attach and weld on the top side in place before installing sheet metal. The sheet metal for the top of lid will be cut into two sheets. First take a measurement from the peak in the center of the lid frame toward the front edge of lip and add 1″ and take the width of the lid from side to side of the outside edges and cut a sheet to those dimensions. Now attach the sheet ⅛″ from the highest peak and flush on the sides with rivets and weld. The front side will have to be cut allowing for 1″ past the lip edge of the frame and then bend the sheet metal over and under the lip edge, rivet and weld. Now measure and cut a piece of sheet metal the width of the lid and the measurement from the peak of the lid to the back outside edge of the lid. Position the sheet metal flush on the edges rivet and weld. Now install the lid lift handle at the front center of the lid with rivets. Cut and strip one track the length of the width of the lid. Use one angle side and bend it to the appropriate angle to fit the peak of the lid then rivet and weld securely.

Installing the Lid onto the box: Position the lid by measuring from both sides centered of the box weld in place the hinge onto the outside of the back wall top tube frame.

Top Plate Sheet Metal on sides: Measure and cut the sheet metal flush with the width and length of the top plate area including the wall lid frame, rivet and weld.

Installing Lifting D-Rings: Install the D-rings on top of the Side wall frames at each corner ½″ from the front or back side and 5/16″ from the side to position over the vertical tubes for strength. Now tighten the nuts from underneath the frame inside the box as the frame was appropriated for access.

Installing Sheet Metal on Corners and Trim

Both Front walls: Measure and cut from the outside of the front wall to the other side at the threshold and add 2″ to the width length. Measure from top to bottom flush for the height, now make a 1″ 90 degree bend on both sides from top to bottom and attach to the wall with rivets and weld.

Side Walls: Measure and cut from front to back flush and top to bottom flush. Attach with rivets and weld.

Back Wall: Measure and cut from side to side flush and top to bottom flush. Attach with rivets and weld.

Installing Corner Trim: Cut and strip Angle Sides to cover all outside edges as trim and security, install with rivets and glue, weld if preferred.

Painting

The toolbox is now ready for painting and decals.

### FABRICATION EXAMPLE 2

Example 2 is given only as a specific example of the present techniques and not meant to limit the present techniques. In certain features, Example 2 may generally correlate with exemplary construction instructions and materials for the toolboxes 10 of FIGS. 1 and 2 (and other embodiments): Again, it should be emphasized that the instructions and materials are only given as examples and not to limit the present techniques. Below is an exemplary material and assembly building list for certain examples and, again, is not meant to limit the present techniques. In one example, metal studs employed are 2½″ (Qty19) 25 gage & (Qty5) 18 gage. Other materials may include: (Qty3) 24 gauge galvanized sheet metal; 4′×10′ Sheet Metal; (Qty500) Aluminum ⅛″ Rivets 3/16″ Head & (Qty68) Steel ⅛″ Rivets ¼″ Head along with metal screws are used accordingly as shown in FIG. 5 for attaching purposes; (Qty2) Corner Braces; (Qty1) Lock Clasp; (Qty1) Lid Handle; (Qty4) Box handles for lifting; (8 ft) Continuous Hinge (ITEM-U); (Qty2) 2″ Strap Hinges (ITEM-Z); 3½″ Aluminum channel; (Qty1) ⅜″ Seal 10′; and (Qty1) ⅝″ Seal 5′

The assembly may be initiated by cutting and building each frame, and performed by attaching one item to the next. In this example, when a frame calls for doubled 25 gage track it may be because the material at hand may benefit from stability, and therefore, once the single frame is built then proceed to double each item as noted. In this example, the tracks are not doubled initially because the assembly may benefit from attaching one layer at a time to provide additional access to the surfaces for riveting. The Metal Track as the frame is typically used like metal studs in a wall (The Lip is used for the covering surface in this example) except when specified on the lid and door. The angle cuts are speed square angles used on the top ends of the track where specified thus giving the box its 2 degree pitch. (Of course, other degree pitches may be employed).

Aluminum ⅛″ Rivets with 3/16″ Heads are used for the entire frame assembly except for attaching the Wall frames to the floor where Steel ⅛″ Rivets with ½″ Heads may be utilized. Once the Bottom Floor Frame is assembled, cut and attach the sheet metal to the dimensions provided under the diagram and primer paint the bottom for extra corrosion prevention. Sheet metal dimensions are provided under each Wall frame. However, the sheet metal may not be needed until the entire wall frames are assembled and attached to the floor. It should be noted that the exterior sheet metal dimensions provided under the wall frames may facilitate covering the wall exterior as well as half of the floors exterior.

The floor may have the 18 gage Track with the 2½″ Front facing outward and one side of the 1½″ lip used for the floor cover surface thus the track is visually sideways. Items may include: (Qty2) 60″ Front and Back 18 gage Track; (Qty6) 34¼″ 18 gage Track every 12″ between Front and Back; and (Qty4) 16″ 18 gage Track as Cross Corner Brace. In one example, the bottom floor size is to cut Sheet Metal (Qty1) 60″×34¼″ and attach for floor, and paint the bottom with primer. As for an exemplary back wall frame, items may include: (Qty3) 41″ vertical 25 gage track with 2 degree hip valley cut on top from back to front; (Qty1) 60″ 18 gage Track for the top; (Qty2) 27″ Cross brace for each side of the center vertical stud to top plate; and (Qty1) 60″ 25 gage Track for the bottom. The back wall exterior size may be (Qty1) 43″×60″.

As for the left and right side wall frames, items may include: (Qty1) 40⅝″ Back vertical 25 gage track; (Qty1) 37⅝″ Front vertical 25 gage track; (Qty1) 29 3/16″ Horizontal Top 25 gage track; (Qty1) 29″ Horizontal Bottom 25 gage track; and (Qty1) 27″ Cross Brace connected from Back vertical 25 gage track to Top 25 gage track. The left and right exterior wall size may be (Qty1) Cut Sheet Metal 34¼″ wide X 43″ on one side (E) for the back and 39″ on the other side (F) for the front. A chalk line, for example, may be used for marking purposes. As for the left and right front wall frames, items may include: (Qty2) 18″ Top and Bottom Horizontal 25 gage track; (Qty2) 37″ Vertical 25 gage track with 2 degree angle cuts for the top side from back to the front; and (Qty2) 16″ 25 gage track for corner cross braces. The front left and right wall exterior size may to cut sheet metal (Qty1) 18″×39″.

As for the top lid frame, the 25 gage track is not doubled initially. Items may include (Qty6) Three 64″ 25 gage Tracks are turned upside down and connected on top of Item-R with two rivets on each end flush for the Back, Middle and Front. The other three 64″ 25 gage Tracks are then used to double for the top contact surface. Six rivets, three on each side. Items may include: (Qty2) 64″ 25 gage Tracks are doubled for the front face. Use three rivets on one side and then put it flush to the bottom of the Front 64″ Stud with ITEM-P and attach; (Qty2) 37″ 25 gage Tracks are sideways with face turned out. A 2 degree common angle is cut on each end; (Qty2) 37″ 25 gage Tracks used to cover and cap each side by notching out to fit the inside and keep the tabs to cover the ends of ITEM-P on the outside thus the contact surface is used to support the Sheet Metal Exterior; (Qty4) 19″ Two Braces from middle track to the back track and (Qty2) from middle track to front track. The ends are notched at a 45 degree angle and leaving the contact surface to overlap as well as side tabs for more stability; and (Qty2) 4″ Hinges placed 5½″ center from each end and (Qty1) 4″ Hinge at 32″ center of the hinge on top. The Top Lid Exterior Size may be (Qty1) 37½″×65″

Assembly of the front door, in this example, is by attaching single items one side at a time with the 2½″ front surface facing out for the sheet metal exterior. The 25 gage track turned sideways results in a stronger and thinner door by utilizing interlocking corners with notching and over lapping each corner. Items may include: (Qty4) 36½″ Sides 25 gage track are doubled; (Qty4) 24″ Top and Bottom 25 gage track doubled; (Qty1) 24″ 25 gage track Top Middle Brace 5½″ from Top track; (Qty1) 24″ 25 gage track Bottom Middle Brace 9½″ from Bottom track; and (Qty2) 2½″ Door Hinges 3″ from Top and Bottom on outside. The Front Door Exterior Size may be via Cut Sheet Metal (Qty1) 36″×39″.

Accessories, Assembly, and Exterior

Mount frames to floor using ⅛″ Steel Rivets with a ¼″ Head. Attach the frames together with ⅛″ Rivets with a 3/16″ Head.
1. NOTE: A bead of caulk may be applied around the edges before attaching sheet metal to frames.
2. If not already done, Cut the Bottom Floor Sheet Metal, attach with ⅛″ Rivets with ¼″ Head to one side of the 18 gage track's 1½″ Lip surface. Turn the floor over and primer paint the whole bottom for extra corrosion protection.
3. Now Mount Back wall flush to outside onto Bottom floor with rivets.
4. Mount Left and Right Side wall frames flush to the inside of the Back wall frame and to the Bottom floor.
5. Mount Left and Right Front wall frames flush on the outside in each corner with the Side walls and the Bottom floor. Attach (Qty2) corner braces on the top inside front for support at each front corner.
6. Cut the exterior sheet metal for the frame assemblies to the size specified under the diagrams above except for the lid. Apply a bead of caulking ¼″ from the edge outlining the frame surface for the sheet metal. NOTE: the floor frame will need a bead of caulking approximately ½″ from bottom. Now attach the exterior Sheet Metal with rivets.
7. Set the Top Lid onto the box frame and align the two outside hinges on the lid 3½″ from the sides of the box frame. Once aligned, attach all three hinges with the rivets specified. Open the lid and measure 14″ from either side of the lid and mount both 4″ Prop hinges center onto the same 18 gage track as the three hinges but upside down, one for each side with the hinge flush to the inside of the track which is opposite of the three hinges. Now measure and mark 12″ from each side of the box and cut a ⅜″ inch hole that aligns with the end of each Prop hinge to set and lock into. Cut a 3′ piece of shelving channel and use (Qty2) 5/16″ bolt and lock nuts, one per hinge to attach to the hinges. On the center brace of the Top Lid frame on the bottom side, mount a ¼″ eye for the 18″ string that will attach to the center of the 3′ shelving channel connected to the hinges. Attach the 2″ PVC handle to the string threaded through the ¼″ eye. Pull the 2″ PVC handle as you pick up on the lid to disengage the Hinge Props and set the lid down. Now Cut the Top Lid Exterior dimensions and attach the sheet metal to the Top Lid while closed with the rivets specified.
8. Cut a 37¼″ piece of the ½″ Aluminum Channel and mount in on the side of the Left Front wall 1⅜″ from the outside flush to the top and install the ¼″ Weather Strip on the side towards the outside for the door seal. Now attach the Hinges on the Front Door to the outside Right Front wall with both frames flush at the top. Mount the (Qty2) Rod Guides 5″ from top and 5″ from bottom, 1½″ from edge. Set the 3′ Rod in the guides from the top. Shut the door and mark the floor where the insert will be installed. Cut a 172″ hole and install the insert.

What is claimed is:

1. A toolbox comprising:
a body configured to receive casters on a bottom portion of the body, wherein the casters comprise wheels that facilitate movement or relocation of the toolbox;
a lid coupled to the body, the lid comprising a raised portion on a top exterior surface of the lid to facilitate stabilization of the toolbox in a stacked configuration with a second toolbox;
a front door coupled to the body and substantially centered in a front side of the toolbox, wherein the front door is at least 2 feet by at least 2 feet in size, and wherein the front door and the lid provide for multi-access to an interior of the toolbox, and wherein an enclosure of the toolbox is formed by a combination of the body, the lid in a closed position, and the front door in a closed position;
lifting elements coupled to an upper portion of the body on each side of the lid to facilitate lifting of the toolbox and also to facilitate stabilization of the toolbox in the stacked configuration; and
skid components coupled to a lower portion of the body to facilitate lifting of the toolbox and also to facilitate stabilization of the toolbox in the stacked configuration.

2. The toolbox of claim 1, wherein the skid components are configured to engage a lifting vehicle and are also configured to engage a lid on the second toolbox in the stacked configuration, and wherein the skid components mate with a raised portion on the lid on the second toolbox to facilitate stabilization of the toolbox and the second toolbox in the stacked configuration, and wherein the skid components engage lifting elements on the second toolbox to facilitate stabilization of the toolbox and the second toolbox in the stacked configuration.

3. The toolbox of claim 1, wherein the lifting elements comprise rings.

4. The toolbox of claim 1, wherein the lid comprises a lip that overlaps the body and the front door.

5. The toolbox of claim 1, wherein the front door is at least 3 feet by at least 3 feet.

6. The toolbox of claim 1, wherein the toolbox comprises a toolbox, a yard box, a game box, a utility box, a mechanics box, or any combination thereof.

7. The toolbox of claim 1, wherein the toolbox comprises a security locking component.

8. The toolbox of claim 1, wherein the toolbox comprises a bin or a shelf, or a combination thereof.

9. The toolbox of claim 1, wherein the toolbox comprises bins on the interior of the toolbox disposed at the interior front sides of the toolbox on each side of the front door.

10. The toolbox of claim 1, wherein the toolbox comprises an electrical component.

11. The toolbox of claim 1, wherein the body, front door, and lid comprise framing and panels.

12. The toolbox of claim 11, wherein the panels comprise sheet metal.

13. The toolbox of claim 11, wherein the framing comprises angle that is 2½″ or less in size, and comprises aluminum or steel, or a combination thereof, and the framing comprises f comprises tracks that are 18 gage or greater.

14. The toolbox of claim 1, wherein the toolbox incorporates a small interior toolbox.

15. The toolbox of claim 1, wherein the box weighs without casters in the range of about 200 lbs. to about 500 lbs., and weighs with casters in the range of about 200 lbs. to about 450 lbs.

16. The toolbox of claim 1, wherein the raised portion of the top surface of the lid comprises a gable.

17. A method of manufacturing a toolbox, the method comprising:
constructing a body frame, a door frame, and a lid frame;
installing panels on the body frame, the door frame, and the lid frame to form a body, a door, and a lid, respectively, wherein the lid comprises a gable configured to facilitate stability of the toolbox in a stacked configuration with another toolbox;
installing a lid handle on the lid and a door handle on the door;
coupling the door substantially centered to a front of the body;
coupling the lid to an upper portion of the body;
installing lifting elements on an upper portion of the body, wherein the lifting elements facilitate lifting of the toolbox, and also facilitate stability of the toolbox in the stacked configuration; and
installing skid components on a lower portion of the body, wherein the skid components facilitate lifting of the toolbox, and also facilitate stability of the toolbox in the stacked configuration.

18. The method of claim 17, wherein the raised portion of the top surface of the lid comprises a gable.

19. A stacked configuration comprising:
a first toolbox;
a second toolbox stacked on top of the first toolbox, wherein the first toolbox and the second toolbox each comprise:
a body;
a lid coupled to the body, the lid comprising a raised portion on a top exterior surface of the lid;
a front door coupled to the body and substantially centered in a front side the body, wherein the front door is at least 2 feet by at least 2 feet in size, and wherein the front door and the lid provide for multi-access to an interior of the body, and wherein an enclosure is formed by a combination of the body, the lid in a closed position, and the front door in a closed position;
lifting elements disposed on an upper portion of the body on each side of the lid to facilitate lifting; and
skid components disposed at a lower portion of the body to facilitate lifting; and wherein:
the lifting elements of the second toolbox engage the skid components of the first toolbox to reduce front-to-back motion and back-to front motion of the first toolbox and the second toolbox; and
the raised portion of the lid of the second toolbox engages the skid components of the first toolbox to reduce side-to-side motion of the first toolbox and the second toolbox.

20. The stacked configuration of claim 19, wherein the lifting elements comprise rings, and the raised portion of the lid comprises a gable.
